(19) United States
(12) Patent Application Publication
(10) Pub. No.: US 2026/0004953 A1
(43) Pub. Date: Jan. 1, 2026

(54) HYPERCONDUCTING ARRANGEMENT

(71) Applicant: GKN AEROSPACE SERVICES LIMITED, Solihull (GB)

(72) Inventors: Simon Taylor, Solihull (GB); Daniel Malkin, Solihull (GB)

(21) Appl. No.: 18/881,731

(22) PCT Filed: Jul. 5, 2023
(86) PCT No.: PCT/GB2023/051769

§ 371 Date: Jan. 7, 2025

(30) Foreign Application Priority Data
Jul. 8, 2022 (GB) 2210069.7

(51) Int. Cl. H01B 12/16; B64D 27/355; H01B 12/12; H01M 8/04082

(52) U.S. Cl. CPC H01B 12/16; B64D 27/355; H01B 12/12; H01M 8/04208; H01M 2250/20

(57) ABSTRACT

The present invention relates to electrical network comprising an electrical conductor and, a cryogen source configured to hold cryogen, the cryogen source arranged so that, in use, cryogen is provided to the conductor to maintain the conductor in a hyperconductive state.

### TECHNICAL FIELD

The present invention is concerned with electrical networks. In particular, to electrical networks that can be improved in efficiency by virtue of cooling using liquid hydrogen or other cryogens. It is known that the trait of superconductivity can enable highly efficient electrical networks as the electrical resistance of certain materials drops to zero below a critical temperature.

This superconducting behaviour has a large number of benefits such as high component efficiency, low heat loss and the use of liquid hydrogen is a known way to maintain the superconducting behaviour of components.

Propulsive systems are now turning to alternative fuels to reduce environmental impact of emissions. Electrically powered vehicles and hydrogen-powered vehicles are currently in development for wider use.

In particular, in aircraft, while hydrogen-powered flight has been discussed there is a leaning in the industry towards use of gas turbines for propulsion for many technical reasons. These reasons include the ability to account for the additional power required at take off and climb stages of flight as well as being reasonably effective and efficient during cruise.

Therefore, while there are recognized environmental benefits from the use of alternative fuels, these are not yet widespread. Gains in efficiencies that can be provided using superconducting materials are not yet accepted as a solution strong enough to encourage deviation from typical fuels and standard combustion. However, where alternative, cryogenic fuels are used, obtaining the advantages possible from superconducting arrangements is very attractive.

In order to encourage use of alternative fuels, and thereby reduce environmental impact of transport by vehicles, whether on land, in sea or in air, developments are required.

Aircraft, or other vehicle, bus bars and power cables are specific examples of components within electrical networks. Such networks may also include electrical converters, fuel cells, motors, generators and propellers or the like. Bus bars and power cables are typically, but in the case of bus bars not always, electrically isolated within the network by a dielectric layer or insulation layer.

The inventors of an invention described herein have created a new solution for provision of low temperature electrical efficiencies that may be used with alternative fuel arrangements for vehicles to make alternative fuels more attractive.

### SUMMARY OF THE INVENTION

Aspects of the invention are set out in the accompanying claims.

Viewed from first aspect there is provided an electrical network comprising: an electrical conductor; and, a cryogen source configured to hold cryogen, the cryogen source arranged so that, in use, cryogen is provided to the conductor to maintain the conductor in a hyperconductive state.

Such a network has high electrical efficiency, is lightweight, and is more robust than modern systems that utilise superconducting arrangements.

In an example, the electrical network further comprises a fuel cell stack electrically connected to the electrical conductor, wherein the cryogen source is arranged at a cryogen upstream end of the network, the fuel cell stack is arranged at a cryogen downstream end of the network, and wherein, in use, the cryogen is in liquid phase at the cryogen source and in gaseous phase at the fuel cell stack.

Such a network advantageously utilises the cryogen to increase electrical efficiency while, at the same time, increasing the temperature of the cryogen such that the cryogen is then suitable for use in the fuel cell stack at the downstream end of the network. In this way, the cooling properties of the cryogen are optimally utilised within the arrangement disclosed herein.

In an example, the electrical network further comprises a prime mover arranged to provide movement from electrical energy, wherein the prime mover is arranged between the cryogen upstream end and the fuel cell stack, and wherein, in use, cryogen is provided to the prime mover in liquid phase.

This arrangement allows for the cryogen to be passed to the prime mover at a suitable temperature accounting for the starting temperature of the cryogen and an ideal temperature for interaction with the prime mover. This in turn increases the overall efficiency of the system from both a thermal and electrical standpoint.

In an example, the electrical network further comprises a further electrical conductor arranged to conduct electrical energy at a lower voltage than the electrical conductor, wherein, in use, the further electrical conductor conducts lower voltage electrical energy to at least one electrical control unit.

In an example, the electrical energy conducted by the electrical conductor is around 270 Volts and the lower voltage electrical energy conducted by the further electrical conductor is around 28 Volts.

In an example, the further electrical conductor is formed of aluminium. We have found that aluminium is particularly advantageous for use in such a hyperconducting arrangement.

In an example, the electrical conductor comprises a cryogen carrying portion which, in use, carries a cryogen provided to the conductor by the cryogen source.

In an example, the network is arranged to provide a closed-loop system for cryogen. In this way, there is no loss of cryogen and the cryogen can be re-used. This allows for a higher efficiency system and reduces the need to top-up the cryogen after use of the network.

In an example, the network is arranged to provide cryogen to portions of the network so as to maintain the following portions at the following temperatures: cryogen source at 25 Kelvin; electrical conductor at 25 Kelvin; coils of a motor at 25 Kelvin; power electronics at 80 Kelvin; and, hydrogen mixer at 300 Kelvin. Such an arrangement is highly efficient, spatially, electrically and in terms of the use of cryogen.

In an example, the network further comprises at least one converter, at least one inverter and at least one circuit breaker to control transmission of electrical energy through the network.

Viewed from another aspect there is provided a method of providing propulsion in a vehicle comprising: cooling, with a liquid cryogen, an electrical conductor to a hyperconductive state; cooling, with the liquid cryogen, a prime mover; evaporating, via heat exchange, the liquid cryogen; passing the gaseous cryogen to at least one fuel cell; generating electrical energy in the at least one fuel cell; providing electrical energy from the at least one fuel cell to the electrical conductor for conducting to the prime mover; generating propulsion from the electrical energy provided to the prime mover.

### BRIEF DESCRIPTION OF THE DRAWINGS

One or more embodiments of the invention will now be described, by way of example only, and with reference to the following figures in which:

FIG. 1A shows a schematic cross-sectional view of a standard electrical transmission arrangement for a vehicle;

FIG. 1B shows a schematic cross-sectional view of a new electrical transmission arrangement for a vehicle;

FIG. 2A shows a schematic cross-sectional view of a new electrical transmission arrangement for a vehicle;

FIG. 2B shows a simplified, enlarged version of portion D of FIG. 2A which shows a new electrical transmission arrangement for a vehicle;

FIG. 3 shows a schematic example of a hyperconducting electrical network;

FIG. 4 shows a schematic example of a hyperconducting electrical network;

FIG. 5 shows a flow diagram illustrating a budgeting of liquid hydrogen in an electrical network alongside power losses and temperatures; and,

FIG. 6 shows a flow diagram illustrating a budgeting of gaseous helium in an electrical network alongside power losses and temperatures.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

An invention described herein relates to electrical networks. In particular, this invention relates to electrically efficient, cooled electrical transmission lines in networks and the arrangement of those cooled transmission lines. Such electrical transmission lines may be cables for conducting electricity. Cables described herein may also transport cryogens. The networks may be for use in vehicles and the cryogens used therein may be used for both cooling and generation of propulsion.

An electrical conductor can be cooled using cryogenic fluids such as liquid helium (between around 0 Kelvin to around 4 Kelvin), liquid hydrogen (between around 14 Kelvin to around than 20 Kelvin), liquid neon (between around 24 Kelvin to around 27 Kelvin), liquid nitrogen (between around 63 Kelvin to around 77 Kelvin), and liquid oxygen (between around 55 Kelvin to around 90 Kelvin). Low temperature gaseous helium may also be used. Many superconducting materials are known, these are materials with electrical resistances that drop to nothing (specifically to 0 resistance in direct current [DC] conditions, where alternating current [AC] experiences some slight resistance) once they are cooled beyond a certain “supercooled” temperature—with some consideration for the critical values for external magnetic field and current carrying.

Such materials offer high electrical efficiency transmission systems. However, there are difficulties associated with using superconduction in vehicle arrangements. In particular, superconduction relies upon the materials being permanently maintained in the superconducting phase. If the material drops out of the superconducting phase, the electrical resistance of that material increases from zero. In this instance, the current through the material with a non-zero resistance leads to heating of the material. This, in turn, leads to an increase in the resistance of the material which, again, leads to more heating. When this happens, the positive feedback loop causes a rapid increase in the temperature of the material. This heat is transferred into the nearby coolant (liquid hydrogen or the like) which is then boiled off in vast quantities. This is known in some fields as a “quench”. A “quench” can also occur if the current through the superconducting material exceeds the critical current value of the material.

Such “quench” events can be very dangerous, can severely damage electrically connected components, and can waste significant amounts of cryogen. In particular, if these events were to occur on an aircraft or other similar vehicle, the safety of passengers may be compromised.

An invention described herein relates to a cooled electrical network for efficient electrical transmission. The network also has increased safety aspects by significantly lowering the risks associated with typical electrical solutions and superconduction. The network disclosed within is also less space intensive than present solutions. As mentioned above, the network of the present invention utilises an electrical transmission, which may be a bus bar or cable, of new design.

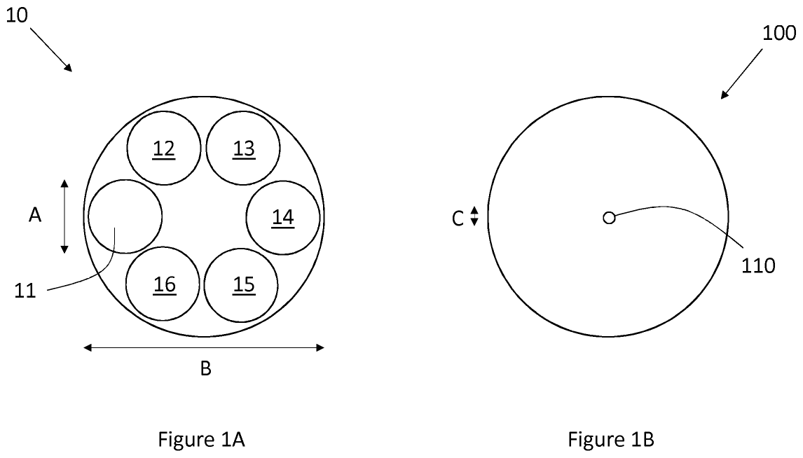

Referring now to FIG. 1A, there is shown a typical electrical transmission 10 comprising a series of cables 11, 12, 13, 14, 15, 16. Typical cables may be made of copper each having a diameter A of around 16 mm for a transmission diameter B of around 55 mm.

In common electrical buses in aircraft, conductors are in ambient air conditions or sometimes have blown air for the purpose of cooling. The heat transfer of such current carrying conductors can occur through conduction (often dominated by axial conduction into cold bays), convective cooling which is limited at flight altitudes in unpressurized bays (typically around 20,000 to 40,000 feet) or radiative thermal emission. When the conductor is hotter than a bay into which the conductor is going, heat will be lost axially. Axial conduction of heat into cold bays occurs along the conductor from one structural boundary that is warmer to one structural boundary that is colder.

For this reason, the heat transfer of such conventional bus and power cable systems is limited. Typically, power bus systems are routed in the fuselage of the aircraft and in unpressurized areas of the aircraft. This routing of the power bus is predominantly in unpressurized areas of the aircraft for aircraft that use electrical propulsion—i.e. using alternative fuels as discussed above.

Due to these limitations and to enable high power transfer of, e.g., 1 MW electrical power, the design may need 6 OFF 4/O gauge cables of total conductor cross sectional area 643 mm² in copper. This is the arrangement shown in FIG. 1A. 4/0 here refers to the American Wire Gauge rating, where 4/0 has a diameter of 0.46 inches or 11.684 mm.

A way to reduce the joule heating effect is to utilise higher voltages. The highest DC voltage seen on aircraft today is 270V DC. For some potential electrical propulsion aircraft, voltages in the range of from 700V DC, 1 kV DC and up to around 3 kV DC are considered. These very high voltages are challenging due to partial discharge effects that can occur at voltages above 327V at any pressure or distance (327 V being the minimum breakdown voltage at any pressure or distance in air). This results in greater challenges for integration of such high voltage systems into electrical transmission arrangements or networks.

Some modern propulsion systems utilise cryogens, such as in fuel cell systems. In such systems, there is a cryogen present that may be routed to cool the cable. In this way, the resistivity of the copper is reduced, and therefore gains can be made either in increasing the current carrying capacity of the cable or in reducing the size of the cable while keeping the current carrying capacity the same.

Modern operating temperatures for networks, or portions of networks such as power bus systems, which are typically defined by aircraft environmental and operating conditions, are between −55 to +260° C. In this range, aluminium has a lower conductivity than copper i.e. it has a higher electrical resistance per unit area. However, in an arrangement using a cryogen it is possible to cool the temperature of the power bus system to lower temperatures than this range.

The inventors of the present invention have recognised the risks associated with the superconductive region, looked past the clear benefits from use of this region, and propose a novel system for improving electrical transmissions and networks. Aluminium is less dense than copper and has a similar or lower resistivity than copper when at cryogenic temperatures, around less than 100 Kelvin.

Below 100 Kelvin, we refer to aluminium being in a “hyperconductive” state until the temperature reaches 1.175 Kelvin, when it becomes a superconductor. We define a hyperconductive material as a typically conductive material that undergoes a sharp or non-linear drop in specific resistivity in cryogenic temperatures (less than 100 Kelvin) without reaching a superconductive state. The present invention utilises the hyperconductive state to provide a robust but electrically efficient and effective electrical transmission system and network.

Aluminium is less dense than copper which means that, when comparing the size of a standard copper cabling arrangement at room temperature (FIG. 1A) against an aluminium cabling arrangement in the hyperconductive region (FIG. 1B), there is a significant decrease in the size for the cabling arrangement.

In particular, cooling the aluminium to 20 Kelvin results in a roughly 3500 fold improvement in conductivity compared to room temperature. The conductivity of aluminium at 77 Kelvin is around 324 fold higher than the conductivity of aluminium at room temperature. When the resistivity of aluminium at 20 Kelvin is compared to copper at room temperature, there is a 2246 fold increase. This equates to a reduction in mass of the conductor from aluminium or copper at room temperature to by 5000 and 2246 fold respectively. See table 1 for experimental details of resistivities for aluminium and copper at different cryogenic temperatures.

TABLE 1
Showing Resistivities of Aluminium and
Copper at Different Temperatures

| | Aluminium | Copper |
|---|---|---|
| Temperature (K) | Resistivity (Ω m) | Resistivity (Ω m) |
| 20 | 7.48 E−12 | 3.57 E−10 |
| 50 | 4.76 E−10 | 9.29 E−10 |
| 77 | 2.20 E−09 | 2.39 E−09 |
| 100 | 4.40 E−09 | 3.94 E−09 |
| 150 | 1.00 E−08 | 7.45 E−09 |
| 293 | 2.65 E−08 | 1.69 E−08 |
| 500 | 5.02 E−08 | 2.95 E−08 |

As such, there are significant gains that can be made from the use of coolant, which may already be present in propulsion systems, for converting the cable material into a hyperconducting state.

Table 1 shows that below 77 Kelvin, the resistivity of aluminium drops below that of copper as the lightweight aluminium enters the hyperconductive region. Therefore, the system may advantageously use liquid hydrogen to cool the aluminium components, as liquid hydrogen has a temperature of less than 30 Kelvin. The use of liquid hydrogen as a coolant thereby enables the aluminium to be cooled sufficiently to be more electrically conductive than copper. The use of liquid or gaseous helium can also provide this.

As can readily be understood, as the resistivity of the aluminium drops below that of copper, and accounting for the lower density of aluminium when compared to copper, extremely large gains in the total size and mass of required cable can be made.

Referring now to FIG. 1B, there is shown a hyperconductive electrical transmission 100 comprising an aluminium 1 MW cable 110 at 270V DC (below the Paschen minimum). The hyperconductive electrical transmission 100 is configured for use in a hyperconducting network. Compared to the six copper cables 11, 12, 13, 14, 15, 16 of 16 mm diameter resulting in a total transmission 10 diameter of 55 mm, the hyperconducting equivalent 110 has a diameter of around 2.4 mm; see measurement C in FIG. 1B. Clearly this is a significant size reduction in the electrical transmission size from transmission 10 of FIG. 1A to transmission 100 of FIG. 1B. Further, considering the relative densities, the conductor mass per unit length of electrical transmission 100 is around 16.5 g/m compared to around 7.2 kg/m for transmission 10. Therefore, there is also a significant weight saving when using the hyperconductive arrangement shown in FIG. 1B.

The system 100 presented herein therefore is around 400 times lighter than modern systems and are electrically far more efficient, using less than half the voltage (FIG. 1A uses 700V AC, while FIG. 1B uses 270V DC). Networks using the transmission 100 can therefore benefit from these weight gains. Calculations showing this significant weight reduction are shown in Tables 2 and 3.

Therefore, there are significant gains to be had in the use of a hyperconducting electrical transmission. This may also be referred to as hyperconducting electrical bus, hyperconducting bus, hyperconducting cable.

An option for cooling the cable to the hyperconductive region is to immerse the cable in liquid hydrogen, however this may not be the most efficient or effective method. Therefore, examples of efficient and effective cable configurations are now discussed.

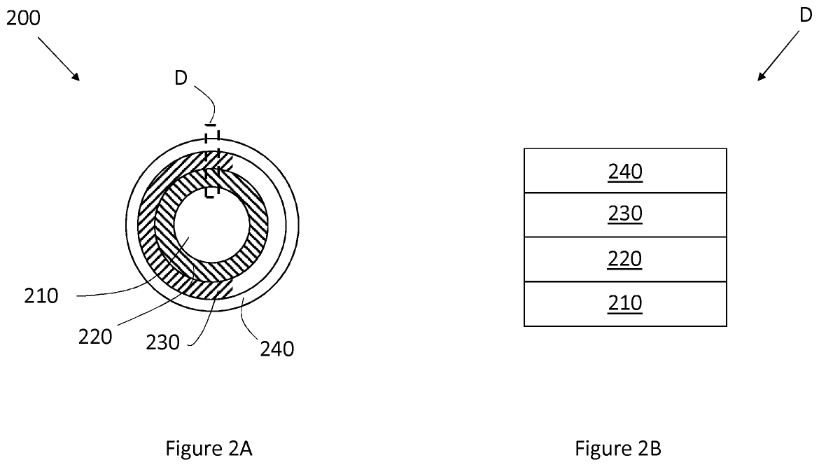

Referring now to FIGS. 2A and 2B, there are shown schematic views of a new electrical transmission arrangement 200 for use in the electrical network of a vehicle. FIG. 2A shows a schematic cross-sectional view of an electrical transmission arrangement 200. FIG. 2B shows an enlarged schematic of portion D of FIG. 2A.

FIG. 2A shows a transmission 200. The transmission 200 has a central core of cryogen, for example liquid hydrogen 210. The transmission 200 has a layer of aluminium 220 surrounding the hydrogen 210. The transmission 200 has a layer of dielectric 230 surrounding the aluminium layer 220. The transmission 200 has an outer surface of insulation 240. The insulation 240 surrounds the dielectric 230.

The cable arrangement 200 of FIG. 2A allows transport of both electrical signals and cryogen 210, therefore this cable provides a double use in a system that uses cryogen and requires transport of that cryogen. Furthermore, the cryogen transport also provides the function of cooling of the aluminium cable 220.

For clarity, FIG. 2B shows an enlarged view of portion D of FIG. 2A. The layers are clearly shown as cryogen 210 in the centre (bottom of FIG. 2B), then aluminium 220, dielectric 230 and insulation 240 on the outermost layer (top of FIG. 2B).

The dielectric 230 and insulation 240 layers provide electrical isolation of the electrical energy being carried in the electrical conductor 220. The cryogen 210 may also act as an electrical insulator.

In use, the aluminium 220 contains the cryogen 210 which may be pressurized liquid hydrogen or cryogenic gaseous hydrogen (or liquid or gaseous helium), while also carrying the current to the required loads. The aluminium pipe 220 would then be surrounded by a layer of dielectric 230 and insulation 240. To simplify manufacturing, this could be a spray on foam or cryogenic blanket and/or a vacuum, as this would allow detection of leaks and is a suitable insulator. Such a construction, and construction techniques, reduces complexity of manufacturing in comparison to an electrical transmission that is immersed in liquid hydrogen which would need to be mechanically supported.

The aluminium pipe 220 is partially supported by the cryogen 210 as the tensile strength increases by up to 40% in cryogenic temperatures. The aluminium pipe 220 can also be strengthened by doping it with graphene, which only has a negligible effect on the conductivity of pipe 220. It is also possible for the aluminium 220 to be supported by a simple, inert and lightweight former (such as a glass reinforced plastic), which would aid in its robustness. As such, these manufacturing steps can be taken to improve the robustness of the design of cable 200.

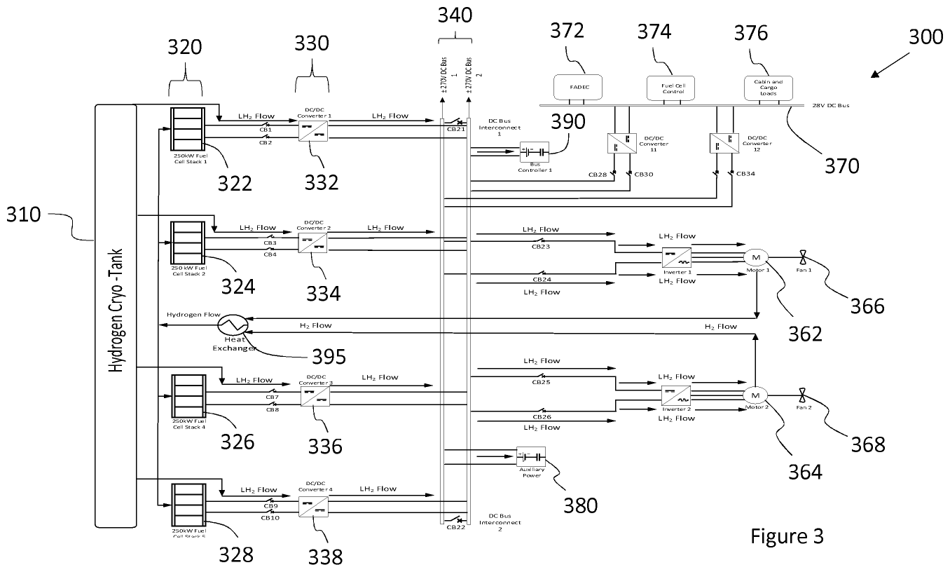

Referring now to FIG. 3, there is shown a schematic view of a new electrical network 300 for use in a vehicle.

The network 300 has a cryogen store 310. The cryogen store 310 may be arranged to hold liquid hydrogen (LH2) or other similar cryogen for use in the network 300. The cryogen may be used to cool the electrical cables in the network as well as other components.

The liquid cryogen may be provided from the cryogen store 310 to a series of fuel cell stacks 320 (once heated suitably, this heating may occur during the cooling of hyperconducting cables or the like or via a heat exchanger). In the example shown, the cryogen store 310 is in fluid communication with four fuel cell stacks 322, 324, 326, 328. The fuel cell stacks 322, 324, 326, 328 may each by a 350 kW fuel cell stack. This renders the total network 300 to be a 1 MW hyperconducting network 300.

Each of the fuel cell stacks 322, 324, 326, 328 is electrically connected to an electrical converter 332, 334, 336, 338. The converters 332, 334, 336, 338 are connected to the electrical transmission 340, which may be an electrical bus bar or the like. The electrical bus bar 340 may have the arrangement as shown in FIG. 2A. The converters 332, 334, 336, 338 are used to regulate the voltage before the high voltage bus bar 340. The fuel cell stacks 322, 324, 326, 328 are connected to the converters 332, 334, 336, 338 via a cryo-cooled circuit breaker 352, 354, 356, 358. The circuit breakers 352, 354, 356, 358 are cooled by the cryogen in the cryogen store 310. The liquid cryogen from hydrogen cryo-tank 310 is provided to the converters 330 and then to the bus bar 340.

The electrical bus bar 340 is arranged to carry electrical signals effectively and efficiently through the network 300. The electrical bus bar 340 is connected to the cryogen store 310 and the cryogen from the cryogen store 310 is arranged to maintain the bus bar 340 in a hyperconductive state. In this way, the advantages of hyperconductivity are introduced to the network of FIG. 3.

The electrical bus bar 340 distributes the electrical power from the fuel cell stacks 322, 324, 326, 328 to either the thrust producing motors 362, 364 or the low voltage (LV) bus 370, which supplies the full authority digital engine control (FADEC) 372, fuel cell (FC) control 374 and cabin and cargo loads 376. The LV bus 370 may have a voltage of around 28 V DC, while the electrical bus bar 340 may have a voltage of around ±270 V DC.

In use, the network 300 could have extra power for take-off supplied by a cryo-cooled batteries and supercapacitors, shown as the auxiliary power store 380 in the example of FIG. 3. In an example, the auxiliary power store 380 may contain energy sufficient for additional go arounds needed during aborted or delayed landing processes. The bus 340 may be controlled by a bus controller 390 that may also contain cryo-cooled passive devices. All the conductors, from the fuel cell stacks 322, 324, 326, 328 to the inverters and LV bus 370 may be formed of hyperconducting aluminium.

The electrical bus bar 340 is connected to thrust producing motors 362, 364 via circuit breakers, and inverters. All of these elements may be cooled by the cryogen from the cryogen store 310. The thrust producing motors 362, 364 are each connected to a fan or propeller 366, 368. The motor and fan/propeller 362, 364, 366, 368 combination act as a prime mover. The prime mover receives electrical energy and converts it into kinetic energy. In particular, in the case of a motor 362, 364 and fan/propeller 366, 368, the electrical energy is received, generates rotational energy in the fan/propeller 366, 368 by the motor 362, 364 and this provides thrust to the system 300 in which the fan/propeller 366, 368 is arranged.

The example of FIG. 3 comprises a heat exchanger 395. The heat exchanger 395 may thermally connect the motors 362, 364 and/or the fan/propellers 366, 368 and the cryogen store 310. The cryogen may have changed from liquid hydrogen (for example) to gaseous form hydrogen while providing a heat exchange function on the elements in the network 300. In this case, the gaseous hydrogen may be provided for use in the fuel cell stacks 322, 324, 326, 328 after having provided a heat exchange function to the motor and fan/propeller elements 362, 364, 366, 368.

The present hyperconducting network provides a large number of efficiency gains over present systems. In particular, the hyperconducting network results in increased efficiency and reduced mass when compared to a More-Electric Aircraft (MEA) network or even a high voltage (HV) network. The aluminium hyperconducting network at 20 Kelvin is compared to MEA and HV networks at room temperatures while delivering 1 MW in power, as shown in Table 2.

TABLE 2
Showing Properties of the presently disclosed Hyperconducting
Network against an MEA Network and a HV Network

| | 20 Kelvin | | |
|---|---|---|---|
| | Hyperconducting | MEA | HV |
| | Network | Network | Network |
| | (at 270 V DC) | (at 270 V DC) | (at 3 kV DC) |
| Resistivity (Ω m) | 7.48 E−12 | 2.65 E−08 | 2.65 E−08 |
| Normalized difference | 1 | 3542 | 3542 |
| in Resistivity to 20 K | | | |
| Losses (I²R) (W) | 49 | 172,719 | 5,596 |

Clearly there are electrical efficiency gains provided by the hyperconducting network of the present disclosure. The systems of Table 2 are a 1 MW electrical network using a 10 m aluminium bus bar.

Additionally, there are structural gains specifically in relation to weight. Table 3 uses the same parameters as Table 2, and only allows the system a 5° C. temperature rise over 1 minute.

TABLE 3
Showing Properties of the presently disclosed Hyperconducting
Network against an MEA Network and a HV Network

| | 20 Kelvin | | |
|---|---|---|---|
| | Hyperconducting | MEA | HV |
| | Network | Network | Network |
| | (at 270 V DC) | (at 270 V DC) | (at 3 kV DC) |
| Cable AWG gauge needed | 10 | 0000 | 0000 |
| to keep temp. rise below | | | |
| 5° C. per minute | | | |
| Number of cables needed | 1 | 210 | 7 |
| Weight of Cables (kg) | 0.14 | 607.9 | 37.6 |
| Volume of conductor | 53 | 225,162 | 13,939 |
| needed (mm²) | | | |

Table 3 clearly shows the advantages in terms of weight and volume of the hyperconducting electrical network disclosed herein.

As shown above, hyperconducting aluminium may be used as a conductor for the bus bar and the feeder cables. The aluminium may be cooled by the LH₂ from a liquid cryogen store, either by being fully immersed in LH₂ or used as a current carrying pipe, see FIG. 2. The hyperconductor will then be enclosed in dielectric and insulation for beneficial behaviour when handling high voltages.

In the arrangement in FIG. 3, the liquid cryogen in the cryogen store 310 provides both a fuel function and a coolant function for the network 300. The liquid cryogen (which may be LH₂, LHe [liquid helium] or gaseous helium) may be stored at around 20 Kelvin in the cryogen store 310 which may be tanks. The cryogen may be stored around or up to 28 K depending on the pressure within the cryogen store 310. The cryogen is used as coolant for the hyperconducting network 300 and its components (including the power electronics). The cryogen may then be used to cool the drive and motor components before returning along the network 300. In particular, the returning stage is shown in FIG. 3 by the heat exchanger 395. After providing the heat exchanger function, and possibly entering the gaseous phase, the cryogen is fed into the fuel cell stacks 322, 324, 326, 328 to be used as fuel. During the journey from cryogen store 310 to fuel cell stacks 322, 324, 326, 328, the cryogen is heated passively by the losses in the components of the network 300 and, at some point, it will become gaseous. In this way, the network 300 is efficiently arranged to maximise the usage of the cryogen in the cryogen store 310.

For a particularly efficient arrangement, the temperature of the LH² is around 0° C. (273K) prior to use as a fuel for the fuel cell stacks 322, 324, 326, 328. If it is not heated to the optimum temperature by being used as a coolant, a heat exchanger (hydrogen mixer) can be used to assist the cryogen in reaching a predetermined temperature, such as 0° C.

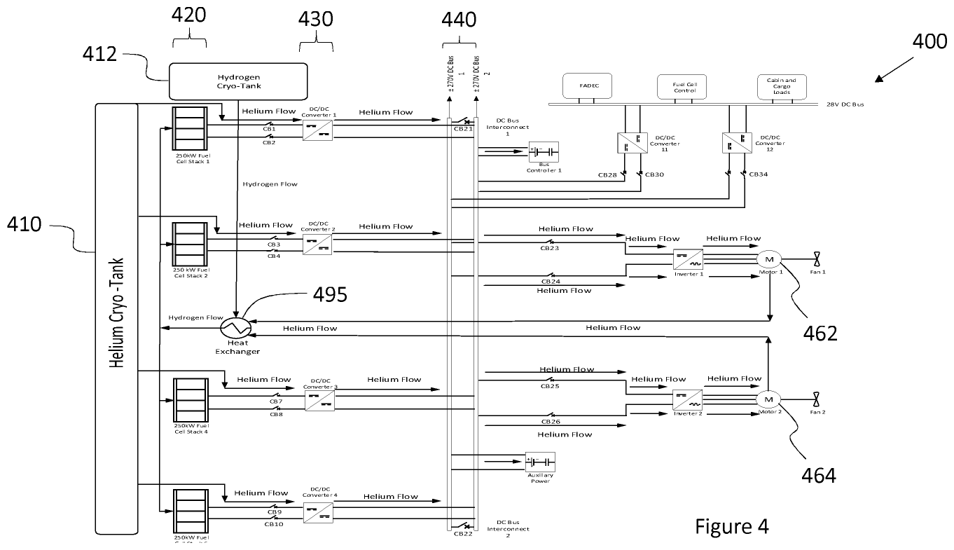

A cryocoolant budget giving the estimated temperature rise at each step is shown in FIG. 4. FIG. 4 shows an example of how the cryogen changes temperature through the network so as to be at a suitable temperature for use in the fuel cell stacks. The rise in temperature of the cryogen is directly related to the losses in the network that are accounted for as temperature rises in components of the network. These temperature rises are accounted for by the cooling function of the cryogen.

FIG. 4 shows a schematic view of a new electrical network 400 for use in a vehicle.

Many of the features of FIG. 3 can be seen in the example of FIG. 4. FIG. 4 differs from FIG. 3 by using a main cryogen store 410 as a store of helium rather than hydrogen (as for FIG. 3). The liquid helium is provided to the converters 430 to provide cooling and then provides cooling to the electrical bus 440. The helium is then provided to inverters and the motors 462, 464.

The helium flow then passes to a heat exchanger 495 and meets a fluid flow from the hydrogen cryogen store 412-not present in the example shown in FIG. 3. The hydrogen and helium combine and the hydrogen flow (now gaseous) is provided to the fuel cells 420 for use in the fuel cells 420.

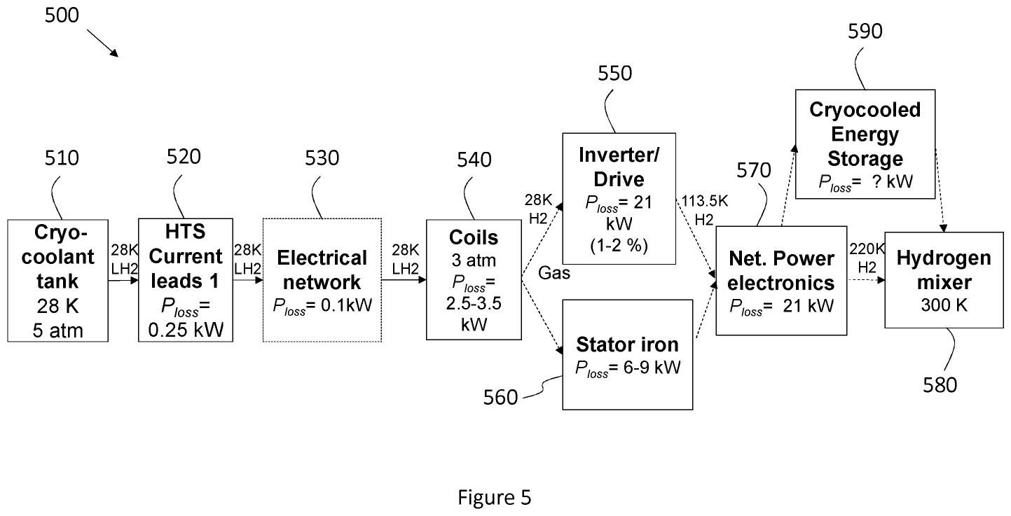

As shown in the example of FIG. 5, in the budget 500 the cryogen store is at 28 Kelvin and 5 atmospheres pressure. The temperatures and pressures may vary from the specific values selected in this example. For example, where 28 K is used, the value may be around 23 to 28 Kelvin. The values of temperatures, provided in the example, will also vary based on the relevant pressures.

In the example shown, this is a hydrogen tank 510. The cryogen at this point is in a liquid phase. The cryogen store feeds the cryogen to the HTS current leads 1 520. The HTS current leads are located in the network broadly where ambient temperature conductor is combined with the cryogen from the tank. HTS are advantageous for being at this location as HTS possess high electrical conduction and low thermal conduction. In this way, the example of FIG. 5 advantageously arranges the HTS current leads 1 520 to improve electrical conduction and reduce the negative impact of thermal loss. The HTS current leads 1 520 are maintained at a temperature of around 28 Kelvin (depending on pressure). The power loss associated with this portion of the network is around 0.25 kW.

Having cooled the HTS current leads 1 520, the cryogen may pass to the electrical network 530. The cryogen may cool the electrical network 530 to around 25 to 30 Kelvin (in an example this may be 28 Kelvin). The power loss associated with this portion of the network is in the region of a few Watts, up to around 100 Watts (0.1 kW). The cryogen in this portion of the network is still in the liquid phase.

The cryogen is then fed to the coils 540 of the network. The coils 540 are maintained at a temperature of around 28 Kelvin and at around 3 atmospheres pressure. The power loss associated with this portion of the network is around 6 kW. This is a fairly significant amount of power to account for in cooling by the cryogen. The cryogen after the coils 540 portion of the network may be in a gaseous form.

The gaseous form cryogen is passed to both the inverter/drive portion 550 and the stator 560. The inverter/drive 550 are maintained at a temperature of around 80 Kelvin. The power loss associated with the inverter/drive portion 550 of the network 500 is around 10 kW to 20 kW due to a 1% to 2% loss, i.e. a 98% to 99% efficiency. This is another fairly significant amount of power to account for in cooling by the cryogen. The cryogen after the inverter/drive 4550 portion of the network 500 is in a gaseous form.

The gaseous form cryogen may also be passed to the stator 560. The stator 560, in an example the iron stator portion 560, may receive cryogen depending on how much cryogen is held in the system. The power loss associated with this portion of the network is around 6 to 9 kW. This is another fairly significant amount of power to account for in cooling by the cryogen. The cryogen after the stator 560 portion of the network 500 is in a gaseous form. The system may include a permanent magnet motor.

The gaseous cryogen is passed from the inverter/drive 550 and the stator 560 to the electrical network 570. The cryogen leaves the inverter/drive 550 at around 115K (shown as 113.5K in the figure) and is passed to the network power electronics 570.

The network power electronics 570 is maintained at a temperature of around 113.5 to 220 Kelvin. The cryogen leaves the power electronics at a temperature of around 220 K, by virtue of being heated (from around 115K) during thermal interaction with the power electronics. The power loss associated with this portion of the network is around 10 to 21 kW. This is another fairly significant amount of power to account for in cooling by the cryogen. The cryogen after the network power electronics 570 portion of the network remains in a gaseous form and can be passed to the hydrogen mixer 580 at around 220 Kelvin to 300 Kelvin, which is suitable for use in the fuel cell stacks of the network 500. Alternatively, the gaseous cryogen can be passed back to a cryocooled energy storage 590 from the network power electronics 570. More generally, the cryogen after the electrical network portion of the network is in a gaseous form and can be passed to the hydrogen mixer at around 300 Kelvin, which is suitable for use in the fuel cell stacks of the network.

Therefore, the budget shown in the examples of FIG. 5, illustrates how cryogen can be passed through the network providing effective and efficient cooling to the elements that require such cooling and ultimately be delivered to a hydrogen mixer at a temperature suitable for use in a fuel cell.

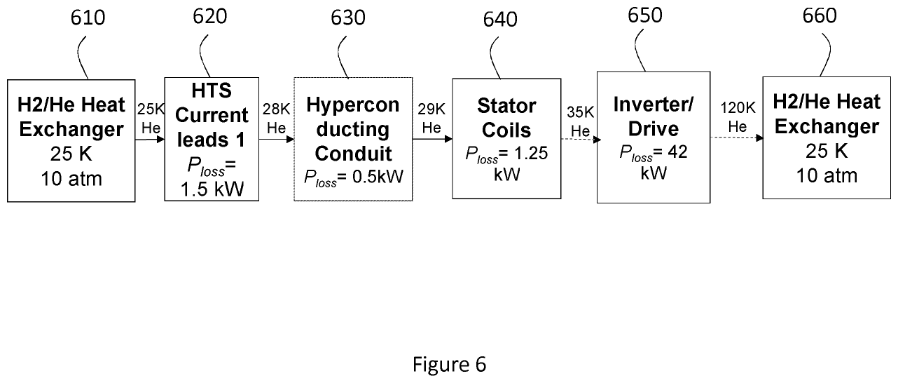

Referring now to FIG. 6, there is a further flow diagram showing a budget utilising low temperature helium rather than hydrogen as per FIG. 5. In FIG. 6, there is a hydrogen/helium heat exchanger where helium is cooled for use with the remaining elements of FIG. 6 while the hydrogen is heated, potentially for use with fuel cells or the like. The heat exchanger is shown as numeral 610. The exchanger may be maintained at 25 Kelvin and 10 atmospheres pressure.

The helium leaving the exchanger is at or around 25 Kelvin. The helium arrives at the HTS current leads 1 620 and provides cooling such that the helium is passed to the hyperconducting conduit 620 at a temperature of around 28 Kelvin. The helium passes the conduit and leaves at a temperature of around 29 Kelvin is then passed to the stator coils 640 and provides further cooling. The helium leaves the coils 640 at a temperature of around 35 Kelvin and is passed to the inverter/drive 650. The helium provides significant cooling to the inverter/drive 650 and leaves the inverter/drive 650 at a temperature of around 120 Kelvin. The helium is then passed to a (or the earlier) heat exchanger 660 to be cooled by a liquid hydrogen source. This then allows the helium to be passed to further components (or the same as shown in FIG. 6). In this way, significant cooling can be provided to the network in a closed loop system. The same benefits as for FIG. 5 are therefore present in the arrangement of FIG. 6.

Another advantage available when using a hyperconducting network is the opportunity to integrate cryo-cooled power electronics (CCPE).

Cooling some semi-conductors down to cryogenic temperatures has been found to significantly reduce the on state losses, in some cases the on state resistance is reduced by a factor of 5, while the switching losses are decreased by 31.25%. Reducing both the on-state losses and the switching losses reduces the amount of cooling needed, thus reducing the weight of CCPE devices. Using liquid hydrogen, for example, as the coolant means no additional cooling is required and, therefore, reduces the total weight of the network further.

We have found that a preferred temperature for the CCPE is around 80 Kelvin, as a lower temperature than 50 Kelvin results in losses beginning to rise again. This development can be beneficially integrated into the network of the present disclosure by selecting when to cool the CCPE by the coolant based on a preferred temperature of the coolant. In a preferred arrangement, the coolant cools the motor and the network so as to provide high efficiencies at low temperatures. The coolant is increased in temperature when cooling the motor and network such that the coolant can then be used for the CCPE, at the preferred temperature of around 80 Kelvin. This is the arrangement as shown in FIG. 4. As such, the arrangement of FIG. 4 is particularly beneficial in both its delivery, and order of delivery, of cryogen to components of the network.

Therefore, there is described herein an effective and efficient electrical network. This system provides a number of advantages as discussed above. By enabling easier use of transport of cryogen and use of high electrical voltages, there are further advantages in the form of easier integration of the use of clean fuels in the generation of propulsion either via combustion of cryogen or via fuel cell electrical generation. This system therefore tangentially assists in the reduction of harmful emissions in modern propulsive systems.

The use of pure, and cryogenic, oxygen and hydrogen enables substantially smaller (more power dense) and lighter mass (higher specific power) propulsion generation in place of modern propulsive systems. Use of liquid hydrogen and oxygen (i.e. as cryogens) also provide advantages in power density and cooling factors.

Although the electrical transmissions used in the electrical networks described herein are discussed as being used with propulsion systems mostly in terms of aircraft, other vehicles such as spacecraft and submarines or the like may carry oxygen, liquid oxygen, or gaseous or liquid hydrogen, for use in propulsion systems using prime movers. Each of these would be benefitted by the presently disclosed network arrangement.

Numerous advantages are provided by a production of propulsion from cryogens rather than say via fossil fuels. The production of water in place of harmful gaseous emissions (NOx, CO2 etc) has clear associated advantages. Furthermore, operation of a vehicle can occur with significantly reduced noise levels. In a particular example, take off and landing phases for aircraft can occur with significantly reduced noise levels due to the lack of high velocity exhaust gas.

Applications for this network arrangement therefore may include automotive, space, domestic or commercial and so forth.

A further benefit of the use of fuel cells over combustion engines as disclosed herein is that microbe colony formation which occurs in existing aircraft kerosene fuel tanks is avoided. The cleaning of such tanks currently requires detergent insecticide cleaners that are somewhat environmentally damaging. In some cases this cleaning may be after each long haul flight. Therefore, the reduction in cleaning has further environmental benefits.

1. An electrical network comprising:
an electrical conductor; and,
a cryogen source configured to hold cryogen, the cryogen source arranged so that, in use, cryogen is provided to the conductor to maintain the conductor in a hyperconductive state.

2. An electrical network according to claim 1, further comprising a fuel cell stack electrically connected to the electrical conductor, wherein
the cryogen source is arranged at a cryogen upstream end of the network,
the fuel cell stack is arranged at a cryogen downstream end of the network, and
wherein, in use, the cryogen is in liquid phase at the cryogen source and in gaseous phase at the fuel cell stack.

3. An electrical network according to claim 2, further comprising a prime mover arranged to provide movement from electrical energy, wherein the prime mover is arranged between the cryogen upstream end and the fuel cell stack, and
wherein, in use, cryogen is provided to the prime mover in liquid phase.

4. An electrical network according to claim 1, further comprising a further electrical conductor arranged to conduct electrical energy at a lower voltage than the electrical conductor, wherein, in use, the further electrical conductor conducts lower voltage electrical energy to at least one electrical control unit.

5. An electrical network according to claim 4, wherein, in use, the electrical energy conducted by the electrical conductor is around 270 Volts and the lower voltage electrical energy conducted by the further electrical conductor is around 28 Volts.

6. An electrical network according to claim 4, wherein the further electrical conductor is formed of aluminium.

7. An electrical network according to claim 1, wherein the electrical conductor comprises a cryogen carrying portion which, in use, carries a cryogen provided to the conductor by the cryogen source.

8. An electrical network according to claim 1, the network arranged to provide a closed-loop system for cryogen.

9. An electrical network according to claim 1, arranged to provide cryogen to portions of the network so as to maintain the following portions at the following temperatures:
the cryogen source at 25 Kelvin;
the electrical conductor at 25 Kelvin;
coils of a motor at 25 Kelvin;
power electronics at 80 Kelvin; and
hydrogen mixer at 300 Kelvin.

10. An electrical network according to claim 1, further comprising at least one converter, at least one inverter and at least one circuit breaker to control transmission of electrical energy through the network.

11. An electrical network according to claim 1, further comprising electrical insulation arranged to form an outer layer of the electrical conductor.

12. An electrical transmission according to claim 1, further comprising a dielectric arranged to provide electrical insulation within the electrical conductor.

13. An electrical network according to claim 1, wherein the electrical conductor is formed of aluminium.

14. An aircraft electrical system comprising the electrical network of claim 1.

15. An aircraft comprising the electrical network of claim 1.

16. A method of providing propulsion in a vehicle, the method comprising:
cooling, with a liquid cryogen, an electrical conductor to a hyperconductive state;
cooling, with the liquid cryogen, a prime mover;
evaporating, via heat exchange, the liquid cryogen, thereby generating gaseous cryogen;
passing the gaseous cryogen to at least one fuel cell;
generating electrical energy in the at least one fuel cell;
providing the electrical energy from the at least one fuel cell to the electrical conductor for conducting to the prime mover;
generating propulsion from the electrical energy provided to the prime mover.
